(19) United States
(12) Patent Application Publication
(10) Pub. No.: US 2018/0122579 A1
(43) Pub. Date: May 3, 2018

(54) WOUND CAPACITOR PACKAGE STRUCTURE HAVING CONDUCTIVE FOILS OF UNEQUAL WIDTH AND WOUND ASSEMBLY THEREOF

(71) Applicant: APAQ TECHNOLOGY CO., LTD., Miaoli County (TW)

(72) Inventors: SHIH-SHAN LIU, TAICHUNG CITY (TW); MING-GOO CHIEN, TAICHUNG CITY (TW); HSUAN-YI LIN, TAICHUNG CITY (TW)

(21) Appl. No.: 15/713,820

(22) Filed: Sep. 25, 2017

(30) Foreign Application Priority Data
Oct. 28, 2016 (TW) 105135063

(51) Int. Cl. H01G 4/32; H01G 4/002

(52) U.S. Cl. CPC H01G 4/32; H01G 4/002

(57) ABSTRACT

The present disclosure provides a wound capacitor package structure and a wound assembly thereof. The wound capacitor package structure includes a wound assembly, a package assembly, and a conductive assembly. The wound assembly includes a wound positive conductive foil, a wound negative conductive foil, and two wound separator papers. The package assembly is used for enclosing the wound assembly. The conductive assembly includes a first conductive pin electrically contacting the wound positive conductive foil and a second conductive pin electrically contacting the wound negative conductive foil. The wound positive conductive foil has a first predetermined width, the wound negative conductive foil has a second predetermined width, each of the two wound separator papers has a third predetermined width, and the first predetermined width of the wound positive conductive foil and the second predetermined width of the wound negative conductive foil are different.

### FIELD OF THE INVENTION

The present disclosure relates to a wound capacitor package structure and a wound assembly thereof, and more particularly to a wound capacitor package structure having conductive foils of unequal width and a wound assembly thereof.

### BACKGROUND OF THE INVENTION

Various applications of capacitors include home appliances, computer motherboards and peripherals, power supplies, communication products and automobiles. The capacitors such as winding capacitors are mainly used to provide the functions of filtering, bypassing, rectifying, coupling, blocking or transforming. The winding capacitor includes a capacitor core, a casing, and a sealing cover. The capacitor core has an anode foil coupled to an anode terminal, a cathode foil coupled to a cathode terminal, a separator, and an electrolyte layer. The anode foil, the cathode foil and the separator are rolled together. The separator is disposed between the anode foil and the cathode foil. The electrolyte layer is formed between the anode foil and the cathode foil. The casing has an opening for receiving the capacitor core. The sealing cover can used to seal the casing, and the anode terminal and the cathode terminal can pass through a through hole of the sealing cover. A given space is provided between the sealing cover and the capacitor core. A stopper for securing the space is provided on at least one of the anode terminal and the cathode terminal.

### SUMMARY OF THE INVENTION

One aspect of the present disclosure relates to a wound capacitor package structure having conductive foils of unequal width and a wound assembly thereof.

One of the embodiments of the present disclosure provides a wound capacitor package structure having conductive foils of unequal width, comprising a wound assembly, a package assembly, and a conductive assembly. The wound assembly includes a wound positive conductive foil, a wound negative conductive foil, and two wound separator papers. One of the two wound separator papers is disposed between the wound positive conductive foil and the wound negative conductive foil, and one of the wound positive conductive foil and the wound negative conductive foil is disposed between the two wound separator papers. The package assembly is used for enclosing the wound assembly. The conductive assembly includes a first conductive pin electrically contacting the wound positive conductive foil and a second conductive pin electrically contacting the wound negative conductive foil. The first conductive pin has a first embedded portion enclosed by the package assembly and a first exposed portion exposed out of the package assembly, and the second conductive pin has a second embedded portion enclosed by the package assembly and a second exposed portion exposed out of the package assembly. The wound positive conductive foil has a first predetermined width, the wound negative conductive foil has a second predetermined width, each of the two wound separator papers has a third predetermined width, and the first predetermined width of the wound positive conductive foil and the second predetermined width of the wound negative conductive foil are different.

Another one of the embodiments of the present disclosure provides a wound capacitor package structure having conductive foils of unequal width, comprising a wound assembly, a package assembly, and a conductive assembly. The wound assembly includes a wound positive conductive foil and a wound negative conductive foil. The package assembly is used for enclosing the wound assembly. The conductive assembly includes a first conductive pin electrically contacting the wound positive conductive foil and a second conductive pin electrically contacting the wound negative conductive foil. The wound positive conductive foil has a first wound outer side, the wound negative conductive foil has a first wound outer side, the first wound outer side of the wound positive conductive foil is correspondingly adjacent to the first wound outer side of the wound negative conductive foil, and the first wound outer side of the wound positive conductive foil and the first wound outer side of the wound negative conductive foil are arranged in a staggered arrangement and separated from each other by a first vertical offset distance.

Yet another one of the embodiments of the present disclosure provides a wound assembly, comprising a wound positive conductive foil, a wound negative conductive foil, and two wound separator papers. The wound positive conductive foil has a first predetermined width, the wound negative conductive foil has a second predetermined width, each of the two wound separator papers has a third predetermined width, and the first predetermined width of the wound positive conductive foil and the second predetermined width of the wound negative conductive foil are different.

Therefore, the distance between the wound outer side of the wound positive conductive foil and the wound outer side of the wound negative conductive foil can be increased by matching the features of “the first predetermined width of the wound positive conductive foil and the second predetermined width of the wound negative conductive foil are different” or “the first wound outer side of the wound positive conductive foil and the first wound outer side of the wound negative conductive foil are arranged in a staggered arrangement and separated from each other by a first vertical offset distance”, so that the prevent disclosure not only can avoid causing a short circuit or an electrical failure between the wound positive conductive foil and the wound negative conductive foil due to arc discharge, but also can increase the electrical performance of the wound capacitor package structure.

To further understand the techniques, means and effects of the present disclosure, the following detailed descriptions and appended drawings are hereby referred to, such that, and through which, the purposes, features and aspects of the present disclosure can be thoroughly and concretely appreciated. However, the appended drawings are provided solely for reference and illustration, without any intention to limit the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 shows a lateral schematic view of the wound capacitor package structure according to the present disclosure;

FIG. 2 shows a perspective schematic view of the wound assembly and the conductive assembly of the wound capacitor package structure according to the first embodiment of the present disclosure;

FIG. 3 shows a partial cross-sectional schematic view of a first type of wound assembly of the wound capacitor package structure according to the first embodiment of the present disclosure;

FIG. 4 shows a partial cross-sectional schematic view of a second type of wound assembly of the wound capacitor package structure according to the first embodiment of the present disclosure;

FIG. 5 shows a partial cross-sectional schematic view of a first type of wound assembly of the wound capacitor package structure according to the second embodiment of the present disclosure;

FIG. 6 shows a partial cross-sectional schematic view of a second type of wound assembly of the wound capacitor package structure according to the second embodiment of the present disclosure;

FIG. 7 shows a partial cross-sectional schematic view of a first type of wound assembly of the wound capacitor package structure according to the third embodiment of the present disclosure;

FIG. 8 shows a partial cross-sectional schematic view of a second type of wound assembly of the wound capacitor package structure according to the third embodiment of the present disclosure; and

FIG. 9 shows a lateral schematic view of the wound capacitor package structure according to the present disclosure.

### DETAILED DESCRIPTION OF THE PREFERRED EMBODIMENTS

Embodiments of a wound capacitor package structure and a wound assembly thereof according to the present disclosure are described herein. Other advantages and objectives of the present disclosure can be easily understood by one skilled in the art from the disclosure. The present disclosure can be applied in different embodiments. Various modifications and variations can be made to various details in the description for different applications without departing from the scope of the present disclosure. The drawings of the present disclosure are provided only for simple illustrations, but are not drawn to scale and do not reflect the actual relative dimensions. The following embodiments are provided to describe in detail the concept of the present disclosure, and are not intended to limit the scope thereof in any way.

### First Embodiment

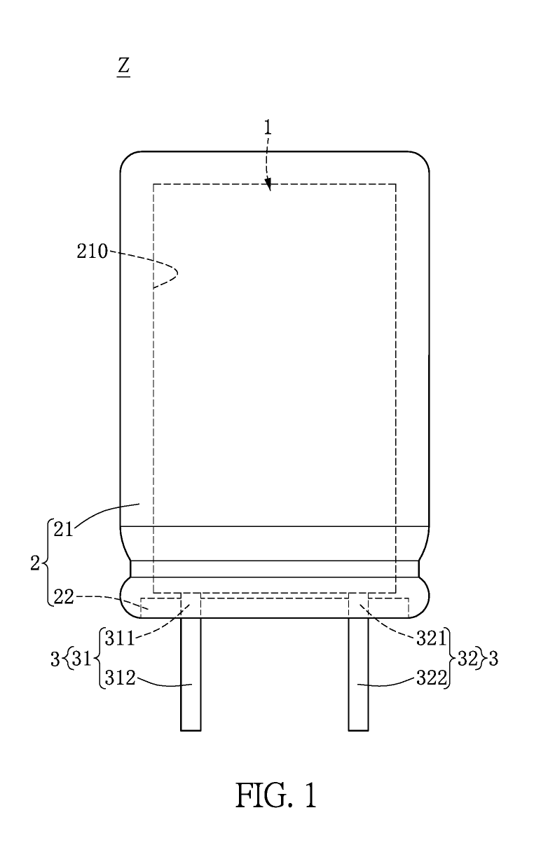

Referring to FIG. 1 to FIG. 4, the first embodiment of the present disclosure provides a wound capacitor package structure Z having conductive foils of unequal width, comprising: a wound assembly 1, a package assembly 2, and a conductive assembly 3.

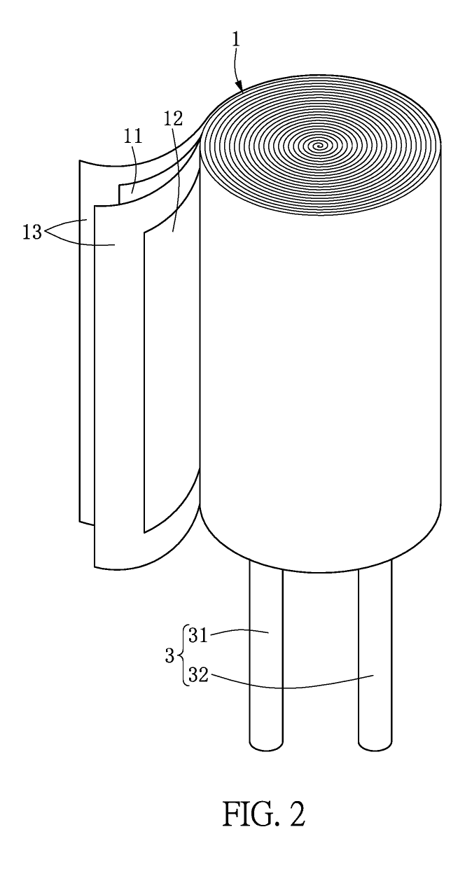

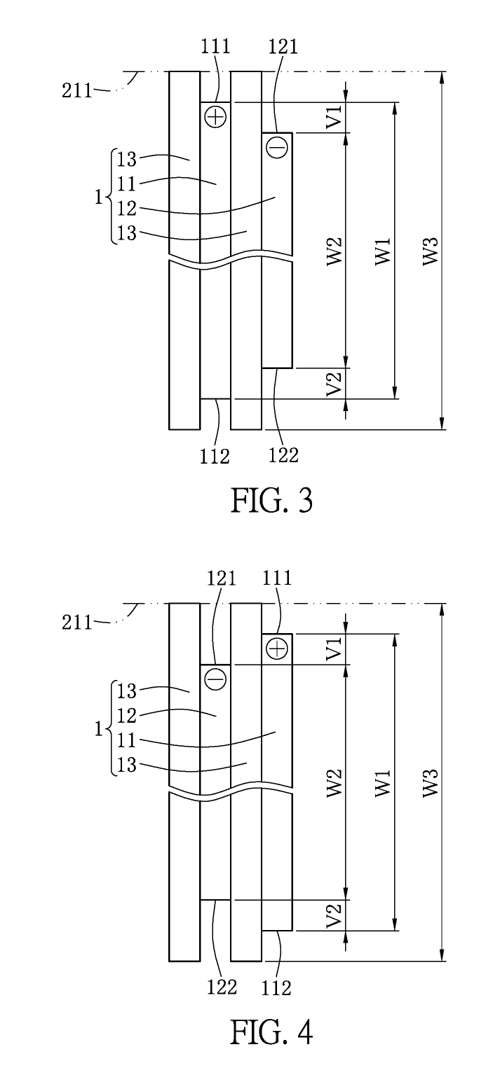

First, referring to FIG. 2 to FIG. 4, the wound assembly 1 includes a wound positive conductive foil 11, a wound negative conductive foil 12, and two wound separator papers 13. More particularly, one of the two wound separator papers 13 is disposed between the wound positive conductive foil 11 and the wound negative conductive foil 12, and one of the wound positive conductive foil 11 and the wound negative conductive foil 12 is disposed between the two wound separator papers 13. For example, as shown in FIG. 3, the wound positive conductive foil 11 is disposed between the two wound separator papers 13. In addition, as shown in FIG. 4, the wound negative conductive foil 12 is disposed between the two wound separator papers 13. It should be noted that the wound separator paper 13 may be a separator paper or a paper foil with conductive polymer by dipping.

Moreover, referring to FIG. 1 and FIG. 2, the package assembly 1 can be used for enclosing the wound assembly 2, that is to say the wound assembly 2 can be capsulated by the package assembly 1. For example, the package assembly 2 includes a capacitor casing structure 21 (such as an aluminum casing or other metal casing) and a bottom enclosing structure 22, the capacitor casing structure 21 has a receiving space 210 for receiving the wound assembly 1, and the bottom enclosing structure 22 is disposed on a bottom side of the capacitor casing structure 21 for closing the receiving space 210. In addition, the package assembly 2 may be an encapsulation body that can be made of any insulation material such as epoxy or silicon.

Furthermore, referring to FIG. 1 and FIG. 2, the conductive assembly 3 includes a first conductive pin 31 electrically contacting the wound positive conductive foil 11 and a second conductive pin 32 electrically contacting the wound negative conductive foil 12. For example, the first conductive pin 31 has a first embedded portion 311 enclosed by the package assembly 2 and a first exposed portion 312 exposed out of the package assembly 2, and the second conductive pin 32 has a second embedded portion 321 enclosed by the package assembly 2 and a second exposed portion 322 exposed out of the package assembly 2.

More particularly, as shown in FIG. 3 or FIG. 4, the wound positive conductive foil 11 has a first predetermined width W1, the wound negative conductive foil 12 has a second predetermined width W2, each of the two wound separator papers 13 has a third predetermined width W3, and the first predetermined width W1 of the wound positive conductive foil 11 and the second predetermined width W2 of the wound negative conductive foil 12 are different. For example, as shown in FIG. 3 or FIG. 4, the third predetermined width W3 of the wound separator paper 13 is greater than the first predetermined width W1 of the wound positive conductive foil 11, and the first predetermined width W1 of the wound positive conductive foil 11 is greater than the second predetermined width W2 of the wound negative conductive foil 12.

It should be noted that the two wound separator papers 13 are abutted against an inner surface 211 of the package assembly 2 so as to support the wound positive conductive foil 11 and the wound negative conductive foil 12 as shown in FIG. 3 or FIG. 4. In addition, the wound positive conductive foil 11 and the wound negative conductive foil 12 are separated from the package assembly 2 by the two wound separator papers 13 so as to prevent the wound positive conductive foil 11 and the wound negative conductive foil 12 from contacting the package assembly 2.

More particularly, as shown in FIG. 3 or FIG. 4, the wound positive conductive foil 11 has a first wound outer side 111 and a second wound outer side 112 opposite to each other, the wound negative conductive foil 12 has a first wound outer side 121 and a second wound outer side 122 opposite to each other, and the first wound outer side 111 and the second wound outer side 112 of the wound positive conductive foil 11 are respectively and correspondingly adjacent to the first wound outer side 121 and the second wound outer side 122 of the wound negative conductive foil 12. It should be noted that the first wound outer side 111 of the wound positive conductive foil 11 and the first wound outer side 121 of the wound negative conductive foil 12 are arranged in a staggered arrangement and separated from each other by a first vertical offset distance V1, and the second wound outer side 112 of the wound positive conductive foil 11 and the second wound outer side 122 of the wound negative conductive foil 12 are arranged in a staggered arrangement and separated from each other by a second vertical offset distance V2.

Therefore, the distance between the outermost side of the wound positive conductive foil 11 and the outermost side of the wound negative conductive foil 12 can be increased by matching the features of “the first predetermined width W1 of the wound positive conductive foil 11 is greater than the second predetermined width W2 of the wound negative conductive foil 12” or “the first wound outer side 111 of the wound positive conductive foil 11 and the first wound outer side 121 of the wound negative conductive foil 12 are arranged in a staggered arrangement and separated from each other by a first vertical offset distance V1, or the second wound outer side 112 of the wound positive conductive foil 11 and the second wound outer side 122 of the wound negative conductive foil 12 are arranged in a staggered arrangement and separated from each other by a second vertical offset distance V2”, so that the prevent disclosure not only can avoid causing a short circuit or an electrical failure between the wound positive conductive foil 11 and the wound negative conductive foil 12 due to arc discharge, but also can increase the electrical performance of the wound capacitor package structure Z.

It should be noted that the two wound separator papers 13 are abutted against an inner surface 211 of the package assembly 2 so as to support the wound positive conductive foil 11 and the wound negative conductive foil 12. That is to say, the wound positive conductive foil 11 and the wound negative conductive foil 12 are separated from the package assembly 2 by the two wound separator papers 13 so as to prevent the wound positive conductive foil 11 and the wound negative conductive foil 12 from contacting the package assembly 2.

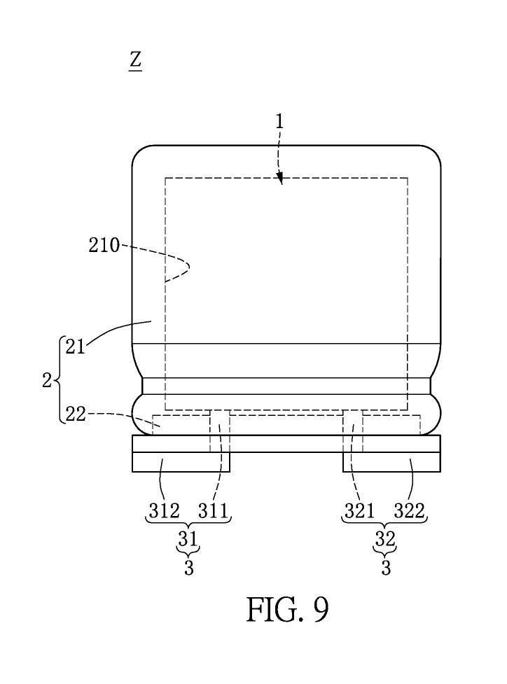

It should be noted that the wound capacitor package structure Z as shown in FIG. 1 can be replaced by the wound capacitor package structure Z as shown in FIG. 9. The difference between the wound capacitor package structure Z as shown in FIG. 9 and the wound capacitor package structure Z as shown in FIG. 1 is as follows: the first exposed portion 312 of the first conductive pin 31 and the second exposed portion 322 of the second conductive pin 32 can be bent about 90 degrees and extended toward two opposite directions as shown in FIG. 9.

### Second Embodiment

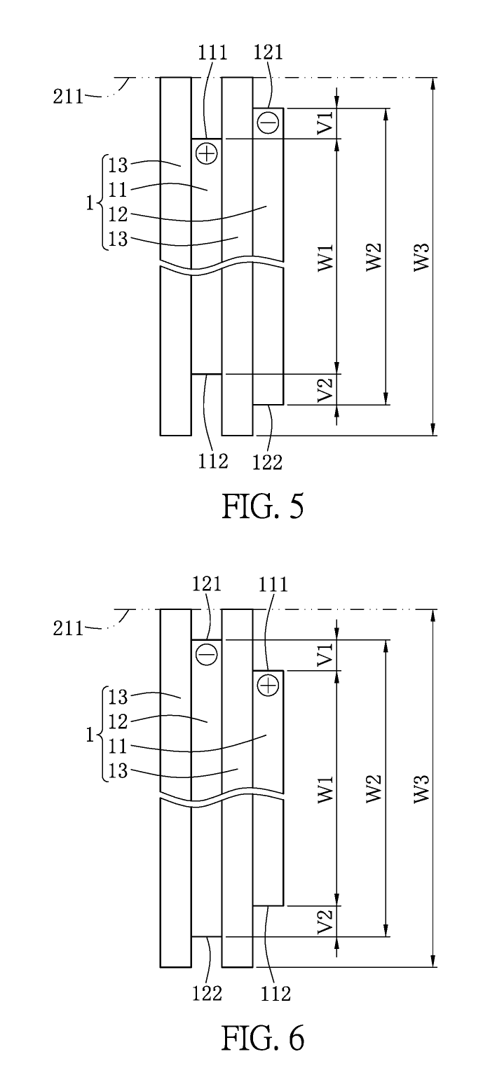

Referring to FIG. 1, FIG. 5 and FIG. 6, the second embodiment of the present disclosure provides a wound capacitor package structure Z having conductive foils of unequal width, comprising: a wound assembly 1, a package assembly 2, and a conductive assembly 3. The wound assembly 1 includes a wound positive conductive foil 11, a wound negative conductive foil 12, and two wound separator papers 13. The package assembly 1 can be used for enclosing the wound assembly 2, that is to say the wound assembly 2 can be capsulated by the package assembly 1. The conductive assembly 3 includes a first conductive pin 31 electrically contacting the wound positive conductive foil 11 and a second conductive pin 32 electrically contacting the wound negative conductive foil 12. For example, as shown in FIG. 5, the wound positive conductive foil 11 is disposed between the two wound separator papers 13. In addition, as shown in FIG. 6, the wound negative conductive foil 12 is disposed between the two wound separator papers 13.

More particularly, comparing FIG. 5 with FIG. 3 or comparing FIG. 6 with FIG. 4, the difference between the second embodiment and the first embodiment is as follows: as shown in FIG. 5 or FIG. 6, in the second embodiment, the third predetermined width W3 of the wound separator paper 13 is greater than the second predetermined width W2 of the wound negative conductive foil 12, and the second predetermined width W2 of the wound negative conductive foil 12 is greater than the first predetermined width W1 of the wound positive conductive foil 11.

Therefore, the distance between the outermost side of the wound positive conductive foil 11 and the outermost side of the wound negative conductive foil 12 can be increased by matching the features of “the second predetermined width W2 of the wound negative conductive foil 12 is greater than the first predetermined width W1 of the wound positive conductive foil 11” or “the first wound outer side 111 of the wound positive conductive foil 11 and the first wound outer side 121 of the wound negative conductive foil 12 are arranged in a staggered arrangement and separated from each other by a first vertical offset distance V1, or the second wound outer side 112 of the wound positive conductive foil 11 and the second wound outer side 122 of the wound negative conductive foil 12 are arranged in a staggered arrangement and separated from each other by a second vertical offset distance V2”, so that the prevent disclosure not only can avoid causing a short circuit or an electrical failure between the wound positive conductive foil 11 and the wound negative conductive foil 12 due to arc discharge, but also can increase the electrical performance of the wound capacitor package structure Z.

It should be noted that the two wound separator papers 13 are abutted against an inner surface 211 of the package assembly 2 so as to support the wound positive conductive foil 11 and the wound negative conductive foil 12. That is to say, the wound positive conductive foil 11 and the wound negative conductive foil 12 are separated from the package assembly 2 by the two wound separator papers 13 so as to prevent the wound positive conductive foil 11 and the wound negative conductive foil 12 from contacting the package assembly 2.

### Third Embodiment

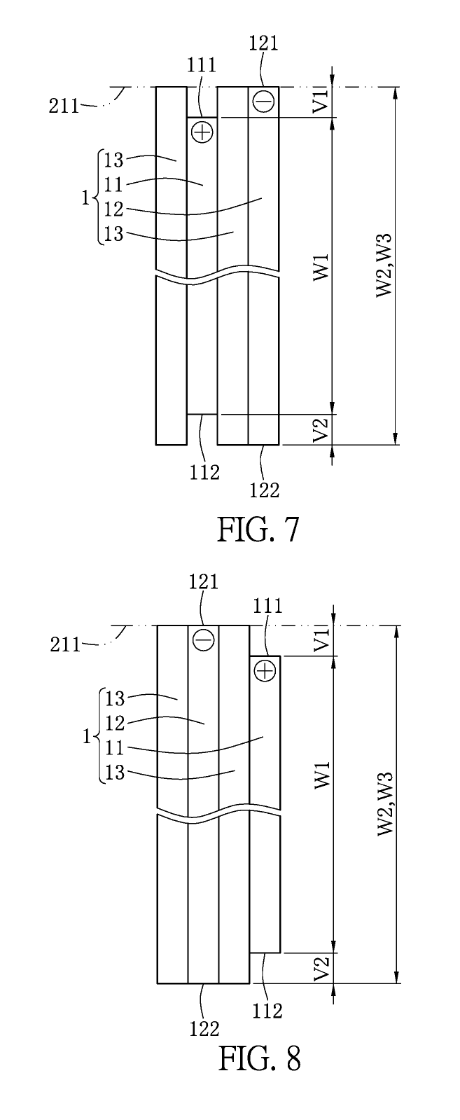

Referring to FIG. 1, FIG. 7 and FIG. 8, the third embodiment of the present disclosure provides a wound capacitor package structure Z having conductive foils of unequal width, comprising: a wound assembly 1, a package assembly 2, and a conductive assembly 3. The wound assembly 1 includes a wound positive conductive foil 11, a wound negative conductive foil 12, and two wound separator papers 13. The package assembly 1 can be used for enclosing the wound assembly 2, that is to say the wound assembly 2 can be capsulated by the package assembly 1. The conductive assembly 3 includes a first conductive pin 31 electrically contacting the wound positive conductive foil 11 and a second conductive pin 32 electrically contacting the wound negative conductive foil 12. For example, as shown in FIG. 7, the wound positive conductive foil 11 is disposed between the two wound separator papers 13. In addition, as shown in FIG. 8, the wound negative conductive foil 12 is disposed between the two wound separator papers 13.

More particularly, comparing FIG. 7 with FIG. 3 or comparing FIG. 8 with FIG. 4, the difference between the third embodiment and the first embodiment is as follows: as shown in FIG. 7 or FIG. 8, in the third embodiment, the third predetermined width W3 of the wound separator paper 13 is equal to the second predetermined width W2 of the wound negative conductive foil 12, and the second predetermined width W2 of the wound negative conductive foil 12 is greater than the first predetermined width W1 of the wound positive conductive foil 11.

Therefore, the distance between the outermost side of the wound positive conductive foil 11 and the outermost side of the wound negative conductive foil 12 can be increased by matching the features of “the second predetermined width W2 of the wound negative conductive foil 12 is greater than the first predetermined width W1 of the wound positive conductive foil 11” or “the first wound outer side 111 of the wound positive conductive foil 11 and the first wound outer side 121 of the wound negative conductive foil 12 are arranged in a staggered arrangement and separated from each other by a first vertical offset distance V1, or the second wound outer side 112 of the wound positive conductive foil 11 and the second wound outer side 122 of the wound negative conductive foil 12 are arranged in a staggered arrangement and separated from each other by a second vertical offset distance V2”, so that the prevent disclosure not only can avoid causing a short circuit or an electrical failure between the wound positive conductive foil 11 and the wound negative conductive foil 12 due to arc discharge, but also can increase the electrical performance of the wound capacitor package structure Z.

It should be noted that the two wound separator papers 13 and the wound negative conductive foil 12 are abutted against an inner surface 211 of the package assembly 2 so as to support the wound positive conductive foil 11. That is to say, the wound positive conductive foil 11 is separated from the package assembly 2 by the two wound separator papers 13 and the wound negative conductive foil 12 so as to prevent the wound positive conductive foil 11 from contacting the package assembly 2.

Therefore, the distance between the wound outer side 111 of the wound positive conductive foil 11 and the wound outer side 121 of the wound negative conductive foil 12 can be increased by matching the features of “the first predetermined width W1 of the wound positive conductive foil 11 and the second predetermined width W2 of the wound negative conductive foil 12 are different” or “the first wound outer side 111 of the wound positive conductive foil 11 and the first wound outer side 121 of the wound negative conductive foil 12 are arranged in a staggered arrangement and separated from each other by a first vertical offset distance V1”, so that the prevent disclosure not only can avoid causing a short circuit or an electrical failure between the wound positive conductive foil 11 and the wound negative conductive foil 12 due to arc discharge, but also can increase the electrical performance of the wound capacitor package structure Z.

The aforementioned descriptions merely represent the preferred embodiments of the present disclosure, without any intention to limit the scope of the present disclosure which is fully described only within the following claims. Various equivalent changes, alterations or modifications based on the claims of the present disclosure are all, consequently, viewed as being embraced by the scope of the present disclosure.

What is claimed is:

1. A wound capacitor package structure having conductive foils of unequal width, comprising:
a wound assembly including a wound positive conductive foil, a wound negative conductive foil, and two wound separator papers, wherein one of the two wound separator papers is disposed between the wound positive conductive foil and the wound negative conductive foil, and one of the wound positive conductive foil and the wound negative conductive foil is disposed between the two wound separator papers;
a package assembly for enclosing the wound assembly; and
a conductive assembly including a first conductive pin electrically contacting the wound positive conductive foil and a second conductive pin electrically contacting the wound negative conductive foil, wherein the first conductive pin has a first embedded portion enclosed by the package assembly and a first exposed portion exposed out of the package assembly, and the second conductive pin has a second embedded portion enclosed by the package assembly and a second exposed portion exposed out of the package assembly;
wherein the wound positive conductive foil has a first predetermined width, the wound negative conductive foil has a second predetermined width, each of the two wound separator papers has a third predetermined width, and the first predetermined width of the wound positive conductive foil and the second predetermined width of the wound negative conductive foil are different.

2. The wound capacitor package structure of claim 1, wherein the wound positive conductive foil has a first wound outer side and a second wound outer side opposite to each other, the wound negative conductive foil has a first wound outer side and a second wound outer side opposite to each other, and the first wound outer side and the second wound outer side of the wound positive conductive foil are respectively and correspondingly adjacent to the first wound outer side and the second wound outer side of the wound negative conductive foil, wherein the first wound outer side of the wound positive conductive foil and the first wound outer side of the wound negative conductive foil are arranged in a staggered arrangement and separated from each other by a first vertical offset distance, and the second wound outer side of the wound positive conductive foil and the second wound outer side of the wound negative conductive foil are arranged in a staggered arrangement and separated from each other by a second vertical offset distance, wherein the package assembly includes a capacitor casing structure and a bottom enclosing structure, the capacitor casing structure has a receiving space for receiving the wound assembly, and the bottom enclosing structure is disposed on a bottom side of the capacitor casing structure for closing the receiving space.

3. The wound capacitor package structure of claim 1, wherein the third predetermined width of the wound separator paper is greater than the first predetermined width of the wound positive conductive foil, and the first predetermined width of the wound positive conductive foil is greater than the second predetermined width of the wound negative conductive foil, wherein the two wound separator papers are abutted against an inner surface of the package assembly so as to support the wound positive conductive foil and the wound negative conductive foil, and the wound positive conductive foil and the wound negative conductive foil are separated from the package assembly by the two wound separator papers so as to prevent the wound positive conductive foil and the wound negative conductive foil from contacting the package assembly.

4. The wound capacitor package structure of claim 1, wherein the third predetermined width of the wound separator paper is greater than the second predetermined width of the wound negative conductive foil, and the second predetermined width of the wound negative conductive foil is greater than the first predetermined width of the wound positive conductive foil, wherein the two wound separator papers are abutted against an inner surface of the package assembly so as to support the wound positive conductive foil and the wound negative conductive foil, and the wound positive conductive foil and the wound negative conductive foil are separated from the package assembly by the two wound separator papers so as to prevent the wound positive conductive foil and the wound negative conductive foil from contacting the package assembly.

5. The wound capacitor package structure of claim 1, wherein the third predetermined width of the wound separator paper is equal to the second predetermined width of the wound negative conductive foil, and the second predetermined width of the wound negative conductive foil is greater than the first predetermined width of the wound positive conductive foil, wherein the two wound separator papers and the wound negative conductive foil are abutted against an inner surface of the package assembly so as to support the wound positive conductive foil, and the wound positive conductive foil is separated from the package assembly by the two wound separator papers and the wound negative conductive foil so as to prevent the wound positive conductive foil from contacting the package assembly.

6. A wound capacitor package structure having conductive foils of unequal width, comprising:
a wound assembly including a wound positive conductive foil and a wound negative conductive foil;
a package assembly for enclosing the wound assembly; and
a conductive assembly including a first conductive pin electrically contacting the wound positive conductive foil and a second conductive pin electrically contacting the wound negative conductive foil;
wherein the wound positive conductive foil has a first wound outer side, the wound negative conductive foil has a first wound outer side, the first wound outer side of the wound positive conductive foil is correspondingly adjacent to the first wound outer side of the wound negative conductive foil, and the first wound outer side of the wound positive conductive foil and the first wound outer side of the wound negative conductive foil are arranged in a staggered arrangement and separated from each other by a first vertical offset distance.

7. A wound assembly, comprising a wound positive conductive foil, a wound negative conductive foil, and two wound separator papers, wherein the wound positive conductive foil has a first predetermined width, the wound negative conductive foil has a second predetermined width, each of the two wound separator papers has a third predetermined width, and the first predetermined width of the wound positive conductive foil and the second predetermined width of the wound negative conductive foil are different.

8. The wound assembly of claim 7, wherein the third predetermined width of the wound separator paper is greater than the first predetermined width of the wound positive conductive foil, and the first predetermined width of the wound positive conductive foil is greater than the second predetermined width of the wound negative conductive foil, wherein the two wound separator papers are abutted against an inner surface of the package assembly so as to support the wound positive conductive foil and the wound negative conductive foil, and the wound positive conductive foil and the wound negative conductive foil are separated from the package assembly by the two wound separator papers so as to prevent the wound positive conductive foil and the wound negative conductive foil from contacting the package assembly.

9. The wound assembly of claim 7, wherein the third predetermined width of the wound separator paper is greater than the second predetermined width of the wound negative conductive foil, and the second predetermined width of the wound negative conductive foil is greater than the first predetermined width of the wound positive conductive foil, wherein the two wound separator papers are abutted against an inner surface of the package assembly so as to support the wound positive conductive foil and the wound negative conductive foil, and the wound positive conductive foil and the wound negative conductive foil are separated from the package assembly by the two wound separator papers so as to prevent the wound positive conductive foil and the wound negative conductive foil from contacting the package assembly.

10. The wound assembly of claim 7, wherein the third predetermined width of the wound separator paper is equal to the second predetermined width of the wound negative conductive foil, and the second predetermined width of the wound negative conductive foil is greater than the first predetermined width of the wound positive conductive foil, wherein the two wound separator papers and the wound negative conductive foil are abutted against an inner surface of the package assembly so as to support the wound positive conductive foil, and the wound positive conductive foil is separated from the package assembly by the two wound separator papers and the wound negative conductive foil so as to prevent the wound positive conductive foil from contacting the package assembly.
